(19) United States
(12) Patent Application Publication
(10) Pub. No.: US 2018/0353004 A1
(43) Pub. Date: Dec. 13, 2018

(54) Systems and Methods for Automated Food Preparation

(71) Applicant: Yuanji Zhu, South Windsor, CT (US)

(72) Inventor: Yuanji Zhu, South Windsor, CT (US)

(21) Appl. No.: 16/102,781

(22) Filed: Aug. 14, 2018

Related U.S. Application Data
(63) Continuation-in-part of application No. 14/683,454, filed on Apr. 10, 2015, now abandoned.
(60) Provisional application No. 62/618,671, filed on Jan. 18, 2018.
(60) Provisional application No. 62/089,833, filed on Dec. 10, 2014.
(60) Provisional application No. 62/062,875, filed on Oct. 11, 2014.

(51) Int. Cl. A47J 36/32; A23L 5/10; A47J 44/00

(52) U.S. Cl. CPC A47J 36/321; A47J 37/1228; A47J 44/00; A23L 5/10

(57) ABSTRACT

Described herein are systems and methods for automatedly preparing food items for consumption. In one aspect, a food preparation system may comprise a refrigeration unit, a cooking unit, a control unit, and a transportation unit configured to transport food items from the refrigeration unit to the cooking unit. The refrigeration unit and the cooking unit may each comprise an aperture configured to receive a portion of the transportation unit such that food items located in the refrigeration unit can be collected by the transportation unit and placed into the cooking unit. In another aspect, a portion of the transportation unit may be placed adjacent the aperture of the cooking unit when a food item is delivered to the cooking unit such that the portion of the transportation unit can function as a lid to the cooking unit.

This non-provisional application claims the benefit of priority to U.S. Non-Provisional patent application Ser. No. 14/683,454, filed Apr. 10, 2015, and U.S. Provisional Patent Application No. 62/618,671, filed Jan. 18, 2018, which is expressly incorporated herein by reference.

### FIELD OF THE DISCLOSURE

The embodiments relate generally to systems and methods for automated cooking and, more specifically, systems and methods for automatedly delivering fresh and sanitary ingredients to a cooking system.

### BACKGROUND

In this fast-paced world, cooking can be a time intensive task for which many lack the time. Waking up in the morning, one's time must be spent on fighting for trying to get up against sleepiness, leaving relatively little time left before rush to work. Such no time, and no mood for preparing meals leads to instant breakfasts (cereals, oatmeals, etc.).

Some auto cooking devices have a refrigeration unit on top of a cooking unit. Food is transferred or dropped to the cooking unit below the refrigeration unit. This leads to two problems. Damage of refrigeration unit by hot air coming upward from cooking unit, and disorder of food ingredients. For example, dropping down, food ingredients may fall apart (such as crab cake, etc.), or overlap, leaving not enough space around each ingredient for a perfect grill.

Some auto cooking devices have part of a refrigeration unit in the same close space with at least part of a cooking unit. This leads to damage of refrigeration unit if grilling above 100 degree Celsius for over 20 minutes. Not to mention the energy efficiency during refrigeration. In order to resist high temperature, the structure of the close space has to use non-plastic materials, such as glass or metal. But these materials have high heat exchange ratio, which ends up with high energy consumption in order to achieve same refrigeration status comparing with a close space made of plastic materials.

Thus, a need exists for improved systems and techniques for the automated preparation of meals using fresh ingredients. Such improved systems and techniques are needed to ensure the quality, accuracy, and reliability of automated-cooking. Moreover, the improved solution must to be affordable, easy to use, and able to fit in a small room.

### SUMMARY OF THE DISCLOSURE

In accordance with certain embodiments of the present disclosure, an automated food preparation system is disclosed. In one aspect, the food preparation system may comprise a control unit, a refrigeration unit, a transportation unit, and a cooking unit. In one embodiment, the control unit may be configured to control one or more aspects of the refrigeration unit, the transportation unit, and/or the cooking unit.

In one aspect, a user may load one or more food items into a refrigeration unit. The user may also configure one or more aspects of the refrigeration unit (e.g., state and/or temperature information).

In accordance with a predetermined schedule set or selected by the user, one or more items may be transported to the cooking unit by the transportation unit. The transportation unit may comprise one or more devices or components for conveying the food items from the refrigeration unit to the cooking unit.

In another aspect, the cooking unit may heat or cook items transported thereto in accordance with a predetermined schedule set or selected by the user. For example, the user may configure one or more aspects of the cooking unit (e.g., state and/or temperature information).

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are illustrative and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an illustrative embodiment of a system as described herein.

FIG. 2A depicts some aspects of an illustrative embodiment of a refrigerating system as described herein.

FIG. 2B depicts some aspects of an illustrative embodiment of a refrigerating system as described herein.

FIG. 2C depicts some aspects of an illustrative embodiment of a refrigerating system as described herein.

FIG. 3 depicts some aspects of an illustrative embodiment of a container of a transporting system as described herein.

FIG. 4 depicts some aspects of an illustrative embodiment of a method as described herein.

FIG. 5 depicts some aspects of an illustrative embodiment of a system as described herein.

FIG. 6 depicts some aspects of an illustrative embodiment of a system as described herein.

### DESCRIPTION OF THE EMBODIMENTS

Disclosed herein are various embodiments of systems and methods for an automated food preparation system. While the systems and methods described herein are primarily concerned with food preparation systems for use in a personal cooking setting, one skilled in the art will appreciate that the systems and methods described below can be used in other contexts, including residential, industrial, and commercial cooking systems, or any other setting in which it may be desirable to automate or remotely-control a food preparation system.

Reference will now be made in detail to certain illustrative embodiments, examples of which are illustrated in the accompanying drawings. Wherever possible, the same reference numbers will be used throughout the drawings to refer to the same or like items.

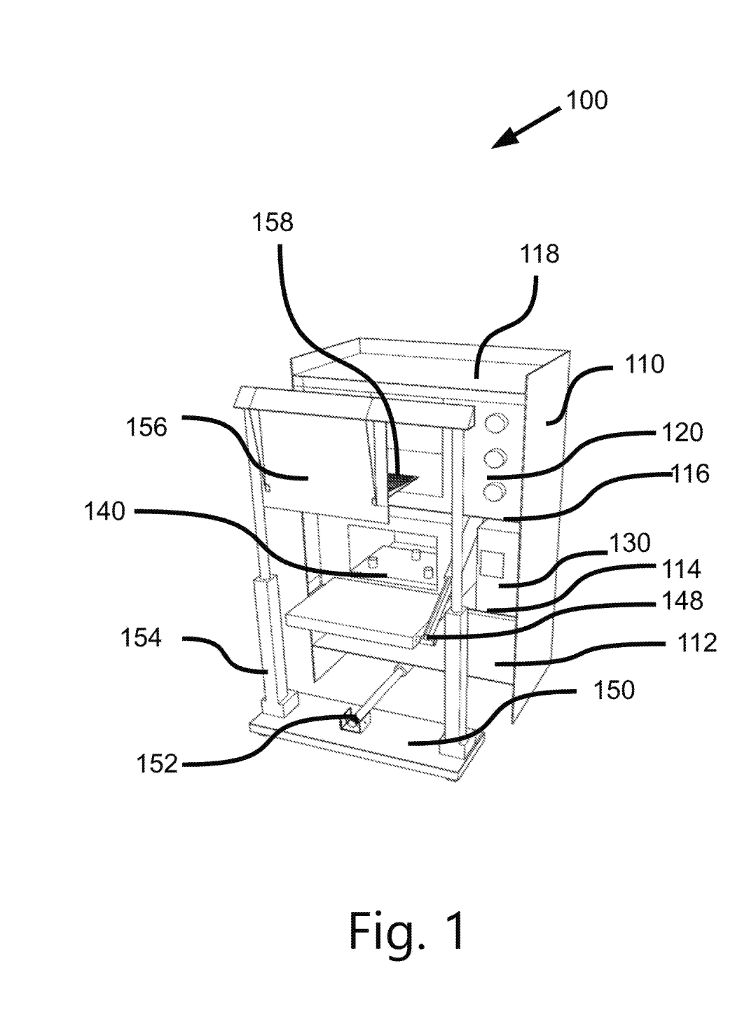

FIG. 1 depicts one illustrative embodiment of an automated food preparation system 100. In one aspect, the food preparation system may comprise a main body unit 110, a cooking unit 120, a control unit 130, a refrigeration unit 140, and a transportation unit 150. In one embodiment, refrigeration unit 140 may be positioned below cooking unit 120. In further embodiments, there may be certain space for ventilation between cooking unit 120 and refrigeration unit 140 (for example, 20 cm distance from top of refrigeration unit 140 to bottom of plane 116). In other embodiments, cooking unit 120 and refrigeration unit 140 may be positioned in any suitable manner so as to reduce or limit heat exchange between the two units. Of course, alternative embodiments are also possible and any suitable arrangement or positioning of main body unit 110, cooking unit 120, control unit 130, refrigeration unit 140, and transportation unit 150 may be implemented.

In another aspect, main body unit 110 may comprise a surface 112, a surface 114, a surface 116, and a surface 118. Kitchen goods may be placed on surface 112. Control unit 130 may be positioned next to refrigeration unit 140, both of which may be stabled on surface 114. Surface 116 may be heat resistant, and can prevent heat exchange between cooking unit 120 and refrigeration unit 140. Part of surface 118 may allow heat exchange from cooking unit 120, such that it may function as a small oven. For example, surface 118 may be used for heating up a cup of water, etc.

In another aspect, cooking unit 120 may comprise an interior cavity, heating systems, a temperature control system (e.g. grill, bake, grill and bake, steam, steam and then grill/bake, etc.), and optionally image processing components. The front face of cooking unit 120 may comprise an aperture for receiving items into the interior cavity.

There may be one or more heating components (not shown) configured to heat the interior cavity of cooking unit 120 to a desired temperature. In one embodiment, cooking unit 120 may comprise an oven, a toaster, steamer, a crockpot, a smoker, a grill, or any other conventional cooking device used in the preparation of food items.

In one aspect, cooking unit 120 may be configured to maintain the contents of its interior cavity at a predetermined temperature within a temperature range. In one embodiment, the temperature range may be 100° F. (38° C.) to 800° F. (427° C.). In other embodiments, cooking unit 120 may be configured to warm, defrost, or thaw its contents below, at, or above room temperature while preventing outside contaminants to contact the contents.

In one aspect, the temperature of cooking unit 120 may be set manually, using an input (e.g., buttons, touchpad, dial, etc.) located at or near system 100. The temperature at which cooking unit 120 may be set may vary depending upon the contents of cooking unit 120, how long the contents will be stored in cooking unit 120, and/or the desired temperature to be reached for the internal temperature of the contents. In one embodiment, the temperature of cooking unit 120 may be set to vary over time, e.g., begin at a first temperature and rise or fall to a second temperature at a predetermined rate. Moreover, cooking unit 120 may be programmed to turn on or off, or vary the temperature within the cavity in accordance with a predetermined time or schedule, and/or based, at least in part, on the occurrence of one or more events.

In other embodiments, cooking unit 120 may comprise image processing systems (such as cameras, computing systems, etc.), which may monitor and recognize numbers/letters/patterns and/or color changes. For example, the image processing systems may monitor the inner cavity of the cooking unit 120. When an item is transported into the inner cavity of the cooking unit 120, the image processing system may recognize a group of numbers, a combination of colors, or a QR code. Matching with the build-in program, the cooking system may auto select the cooking time and/or temperature. During cooking, based on the color change, or shape/pattern changes (such as pop-up timers in turkey, etc.), the image processing system may keep monitoring and adjust/change the status of cooking unit 120 (e.g. cooking temperature, cooking time, etc.).

In another aspect, control unit 130 may comprise a touch screen and buttons for setting and controlling automated food preparation system 100. In one embodiment, control unit 130 may comprise timers, monitors, sensors, and alarms. In further embodiments, control unit 130 may comprise programs (such as recipes, recurring schedules, etc.). Moreover, control unit 130 may comprise buttons configured to control transportation unit 150 manually (e.g. press a certain button, and slide system 152 moves base of transportation unit out, press another button moves back in, etc.).

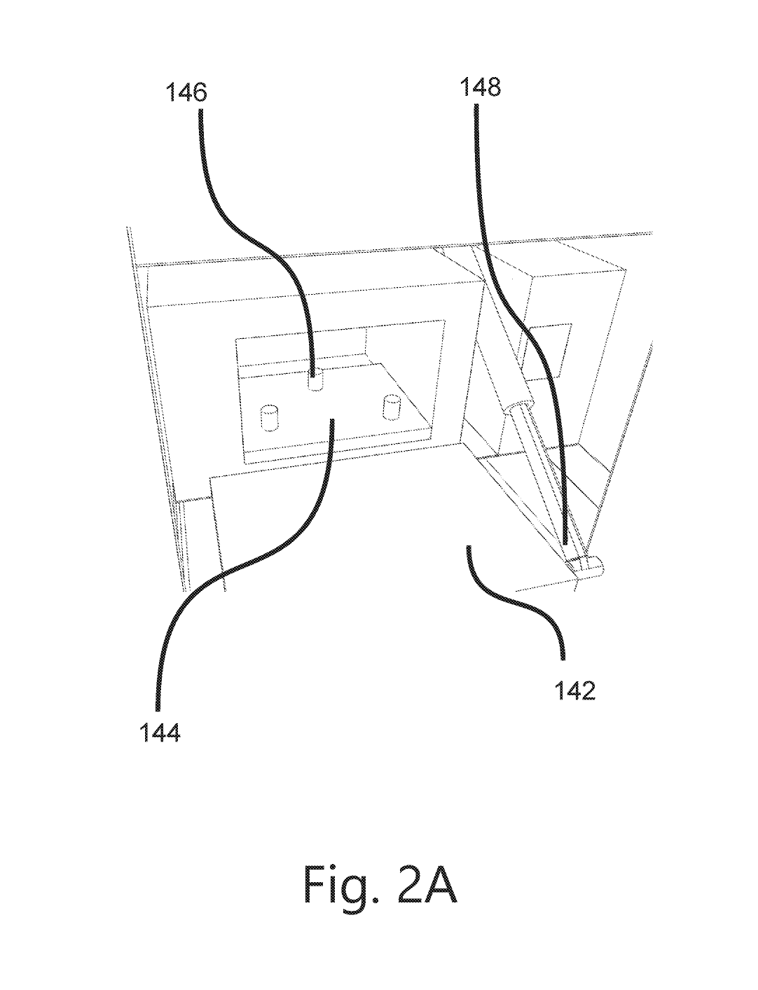

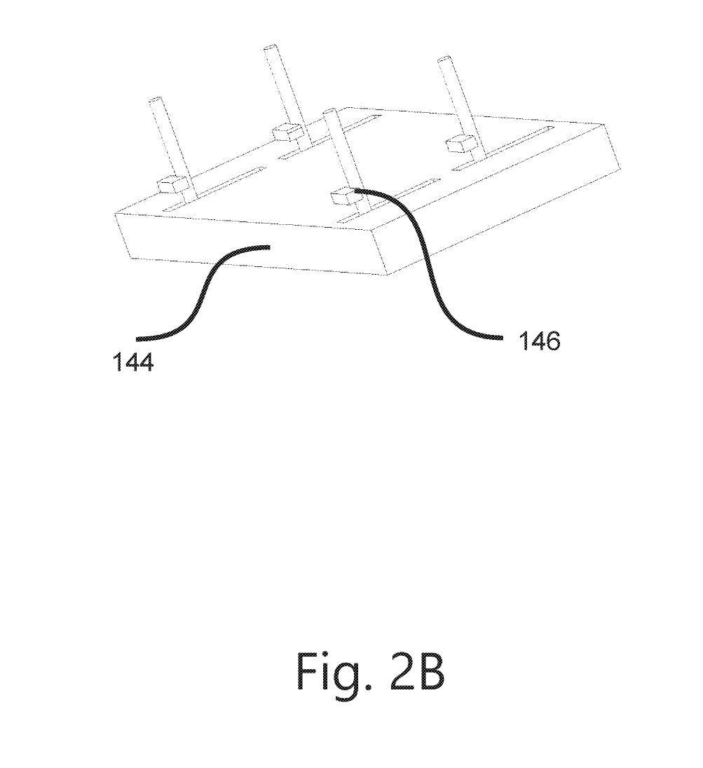

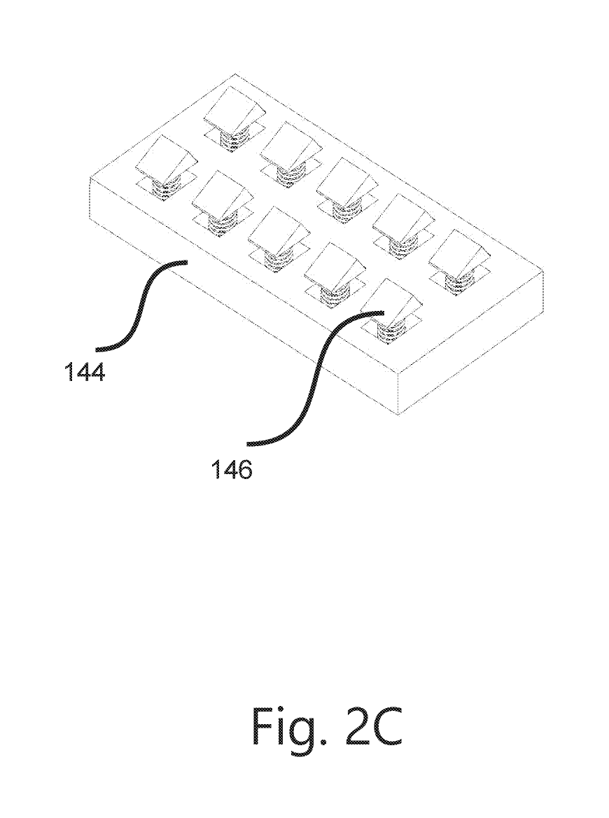

In another aspect, refrigeration unit 140 may comprise an interior cavity, a door 142, a liner 144, support members or dynamic struts 146, and a door open system 148 (as shown in FIG. 2). Like cooking unit 120, the front face of refrigeration unit 140 may comprise an aperture for receiving items into the interior cavity.

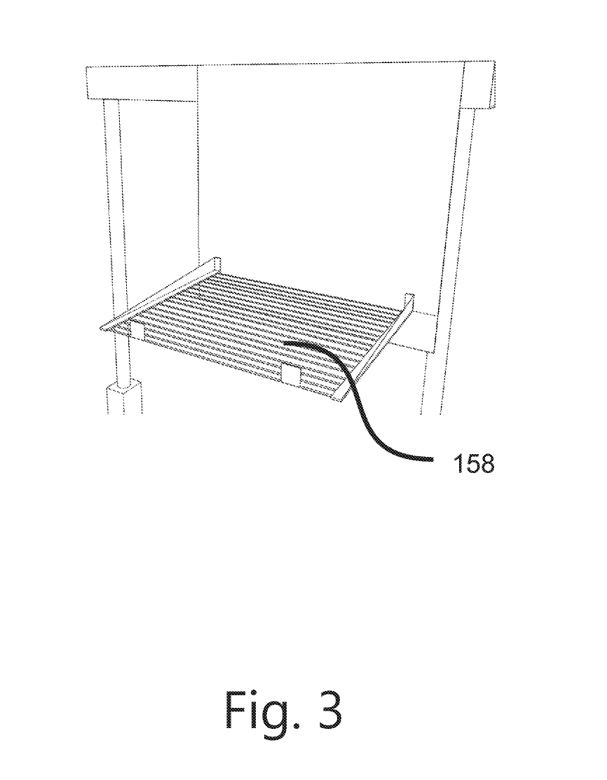

As described in greater detail below, one or more support members or dynamic struts 146 of refrigeration unit 140 may cooperate with support plate or container 158 of transportation unit 150 in the transfer of any contents (i.e., grill plate or any suitable cookware containing food/ingredients) placed in the interior cavity of refrigeration unit 140 to cooking unit 120. It should be noted that although support plate or container 158 is depicted in FIGS. 1 and 3 as a substantially flat member, it could also be a container comprising sides, such as a traditional baking pan.

In a further aspect, refrigeration unit 140 may be configured to maintain the contents of its interior cavity at a predetermined temperature within a temperature range. In one embodiment, the temperature range may be 28° F. (−2° C.) to 45° F. (7° C.). In other embodiments, refrigeration unit 140 may be configured to maintain contents in a frozen state. In such embodiments, the temperature range may be −29° F. (−34° C.) to 45° F. (7° C.). In still further embodiments, rather than a refrigeration unit, unit 140 may serve as a warmer or pre-heater. Alternatively, unit 140 may maintain its contents at substantially room temperature while preventing outside contaminants to contact the contents.

In one aspect, the temperature of the refrigeration unit may be set manually, using an input (e.g., buttons, touchpad, dial, etc.) located at or near control unit 130. The temperature at which refrigeration unit 140 may be set may vary depending upon the contents of refrigeration unit 140, how long the contents will be stored in refrigeration unit 140, and/or the desired temperature of the contents to be placed into cooking unit 120. In further embodiments, the temperature of refrigeration unit 140 may be set to vary over time, e.g., begin at a temperature below room temperature and slowly approach room temperature as the time nears to transport the contents of refrigeration unit 140 to cooking unit 120. Moreover, refrigeration unit may be programmed to turn on or off, or vary the temperature within the cavity in accordance with a predetermined time or schedule, and/or based, at least in part, on the occurrence of one or more events, or recipe/food types.

In another aspect, system 100 may comprise a transportation unit 150. In one embodiment, transportation unit 150 may comprise one or more processor- or controller-based control units, one or more linear actuators, one or more bases, one or more wheels, one or more drawer slides, one or more covers, and one or more support plates.

In one aspect, the base of transportation unit 150 may be positioned under surface 112 of main body unit 110. The base of transportation unit 150 may comprise wheels. In use, slide system 152 may push the base out in a direction substantially perpendicular to a common plane in which the front-facing apertures of refrigeration unit 140 and cooking unit 120 reside. In one embodiment, dynamic base of transportation unit 150 may be configured to slide, via wheels, along opposing drawer slides based, at least in part, on forces exerted on dynamic base of transportation unit 150 by one or more slide system 152. In other embodiments, dynamic base of transportation unit 150 may be configured to move or slide along opposing drawer slides (not depicted in drawing) in some other suitable manner, e.g., a screw-action actuator, gear-and-chain, pneumatic or hydraulic piston, etc.

In one embodiment, cover 156 and support plate 158 may be coupled to one another and positioned substantially perpendicular with respect to one another so as to form a substantially “L-shape” from a side view of the components. In another aspect, cover 156 and support plate 158 may be configured to move vertically (i.e., in a direction substantially parallel to the common plane in which the front-facing apertures of refrigeration unit 140 and cooking unit 120 reside) along opposing support members 154 which may comprise one or more pistons or other members configured for longitudinal extension. In other embodiments, cover 156 and support plate 158 may be configured to move or slide vertically in some other suitable manner, e.g. a screw-action actuator, gear-and-chain, pneumatic or hydraulic piston, etc.

In a further aspect, when support plate 158 of transportation unit 150 moves into the interior cavity of the cooking unit 120, cover 156 of transportation unit 150 may function as a lid to cover the aperture of cooking unit 120.

FIG. 2A depicts refrigeration unit 140. In one aspect, refrigeration unit 140 may comprise an interior cavity, a door 142, a liner 144, support members or dynamic struts 146, and a door open system 148. Door open system 148 may further comprise motors, a linear actuator, and some mechanical parts. Liner 144 may not fully cover the lower surface of interior cavity of refrigeration unit 140. In further embodiments, support members or dynamic struts 146 may be configured to slide/roll/move along the lower surface of liner 144 (or a platform placed on the lower surface of liner 144) based, at least in part, on forces exerted by support plate 158. In use, support members or dynamic struts 146 may drop off a platform located on the lower surface of liner 144 or a raised portion of the lower surface of liner 144 upon sufficient displacement by support plate 158, such that contents (e.g. grill plate, cook wares, etc.) supported by support members or dynamic struts 146 may drop onto the support plate 158 of transportation unit 150. In other embodiments, support members or dynamic struts 146 may be further facilitated by one or more wheels or friction reducing devices.

Of course, support members or dynamic struts 146 may be in any suitable forms (e.g. rotational struts with damping system, etc.), as long as support members or dynamic struts 146 may fall based, at least in part, on forces exerted by support plate 158, and having contents received or otherwise contained by interior cavity of support plate 158 of transportation unit 150. Such an embodiment is depicted in FIG. 2B.

In another embodiment, the lower surface of liner 144 of refrigeration unit 140 may comprise a plurality of openings, each opening configured to receive a respective support member or dynamic strut 146. Each support member 146 can be spring urged away from the lower surface of liner 144 with sufficient force to support contents placed in the interior cavity of refrigeration unit 140 (i.e., grill plate, cookwares, baking pans, food items). When each of the support members 146 is contacted by support plate 158 of transportation unit 150, the support member can be depressed toward the lower surface of liner 144, allowing contents supported by the support members to be received on the upper surface of support plate 158. Such an embodiment is depicted in FIG. 2C.

FIG. 3 depicts another view of support plate 158 of transportation unit 150. In one embodiment, support plate 158 may be grates with one or more extrusions located at free end. The extrusions may serve as a stopper, preventing contents from sliding/moving out of support plate 158. In another embodiment, support plate 158 may comprise one or more reservoirs configured to receive contents (i.e. contents supported on struts 146 of refrigeration unit 140 In other embodiments, support plate 158 may be any other suitable shape/structure (such as grill plate, glass plate, etc.), as long as it may receive contents fall from struts 146 of refrigeration unit 140.

In another aspect, the displacement of contents from refrigeration unit 140 to cooking unit 120 may be accomplished in any suitable manner. In one embodiment, at predetermined schedule, door open system 148 may open door of refrigeration unit 140. Cover 156 and support plate 158 may move out from cooking unit 120, along with base of transportation unit 150 based, at least in part of force exerted by slide system 152. Cover 156 and support plate 158 may then move down, along with lift system 154. Next, cover 156 and support plate 158 may move into inner cavity of refrigeration unit 140, along with base of transportation unit 150 based, at least in part of force exerted by slide system 152. As support plate 158 configured to move/slide into inner cavity of refrigeration unit 140, dynamic struts 146 may fall. Following falling of dynamic struts 146, container 156 may receive contents positioned on dynamic struts 146. Then, cover 156 and support plate 158 may move out, along with base of transportation unit 150 based, at least in part of force exerted by slide system 152. Cover 156 and support plate 158 may then move up, along lift system 154. Following close of door 142 of refrigeration unit 140 based, at least in part of force exerted by door open system 148, cover 156 and support plate 158 may move back to the inner cavity of cooking unit 120, along with base of transportation unit 150 based, at least in part of force exerted by slide system 152.

Any food items located in interior cavity of then covered cooking unit 120 may be heated and or cooked according to a user's preferences.

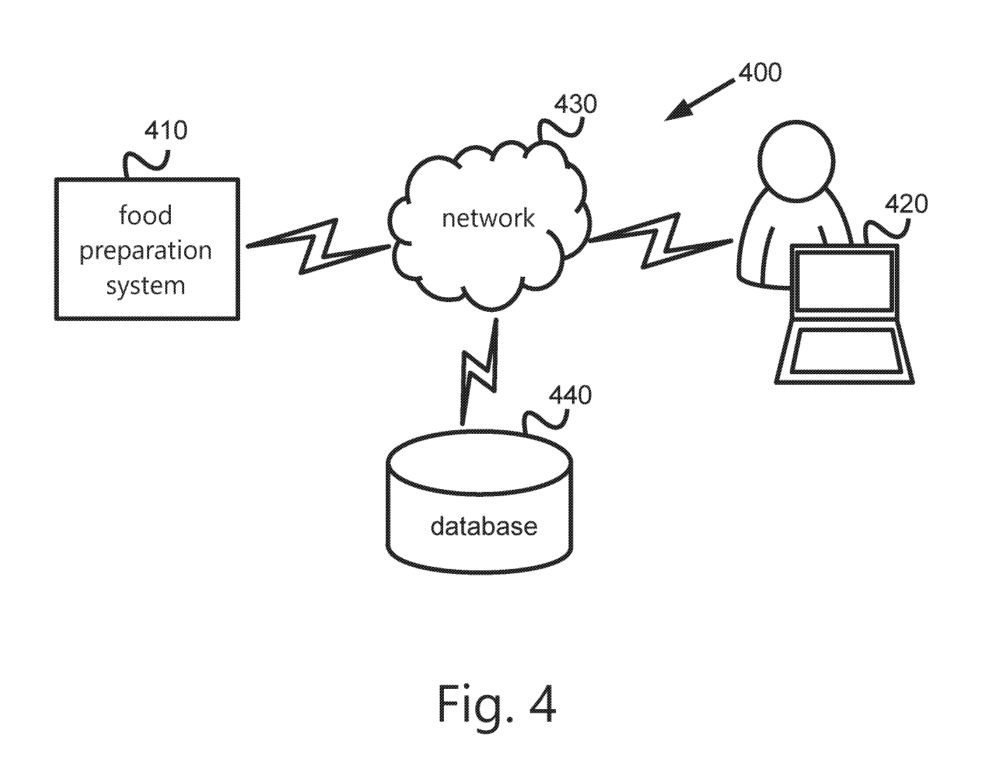

FIG. 4 depicts a communication system 400. In one aspect, communication system 400 may comprise a food preparation system 410 (substantially similar to the system depicted in FIG. 1), a user's communication device 420, and a communication network 430. In one embodiment, communication system 400 may further comprise a database 440.

In another aspect, communication device 420 may comprise any device that a user may use to transmit information to or receive information from food preparation system 410, network 430, and/or database 440. In a further aspect, communication device 420 may comprise one or more buttons, touchscreens, scroll wheels, switches, and other components configured to receive input from a user. In one embodiment, communication device 420 may be a tablet, smart phone, smart watch, laptop, desktop computer, or another processor- or controller-based device configured to accept input(s) from a user, and/or receive and transmit information over a network.

In a further aspect, communication device 420 may be configured to communicate with food preparation system 410 via network 430. In one embodiment, network 430 may be any one- or two-way communication channel, and communication device 420 may be wire- or wirelessly-connected to food preparation system 410. In further embodiments, network 430 may comprise the Internet, an open network, a private/home network, IR, RF, or Bluetooth communication channels, or some combination thereof. In this manner, communication device 420 may be configured to remotely transmit commands to, or receive information from, food preparation system 410. For example, a user may input commands to communication device 420 for turning on or off one or more components of food preparation system 410, setting a temperature or temperature program (temperature variation schedule) of one or more components of food preparation system 410, and/or initiating or scheduling the movement of one or more components of food preparation system 410. In further embodiments, communication device 420 may be used to transmit any commands to food preparation system 410 that the control system of food preparation system 410 may be configured to execute.

In one embodiment, communication system 400 may comprise a database 420. In such embodiments, food preparation system 410 and/or communication device 420 may be configured to transmit information to or recall information from database 440. In further embodiments, database 440 may be configured to store user-specific or profile information, information pertaining to food preparation system 410 settings, recipes or cooking schedules/programs, and/or any other suitable information.

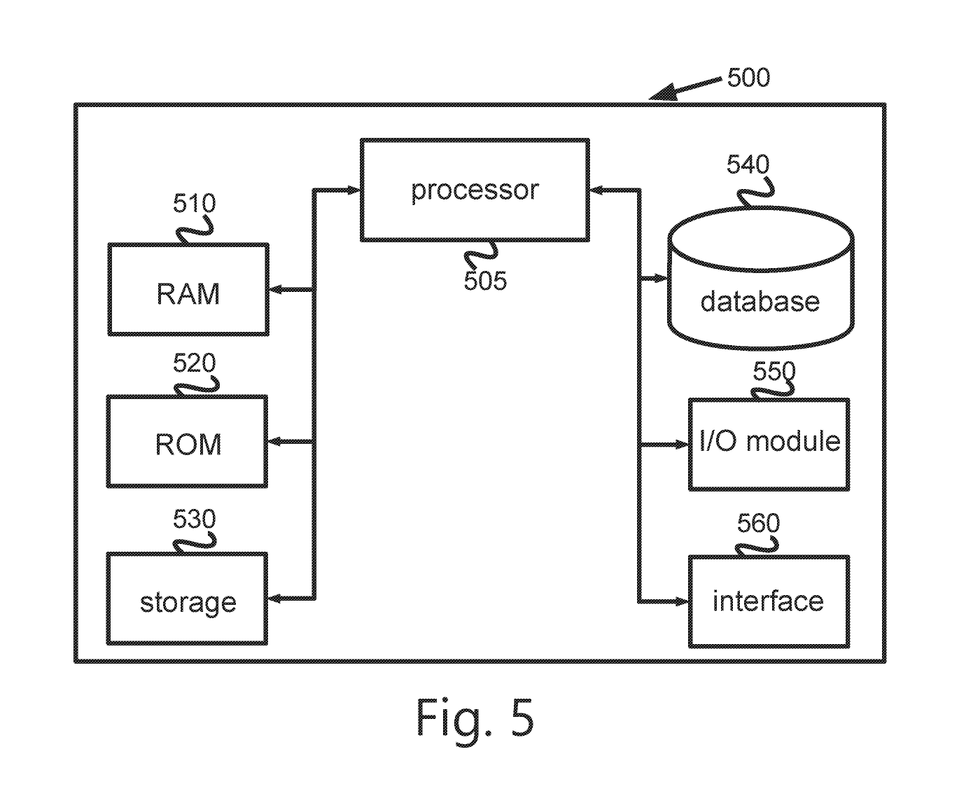

FIG. 5 depicts a processor-based computing system 500 representative of a computing system that may be found in (or cooperate with) any one or more of food preparation system 510, communication device 520, network 530, and/or database 540.

In particular, system 500 may comprise one or more hardware and/or software components configured to execute software programs, such as software or circuitry for storing, processing, and analyzing data. For example, system 500 may include one or more hardware components such as, for example, processor 505, a random access memory (RAM) module 510, a read-only memory (ROM) module 520, a storage system 530, a database 540, one or more input/output (I/O) modules 550, and an interface module 560. Alternatively and/or additionally, system 500 may include one or more software components such as, for example, a computer-readable medium including computer-executable instructions for performing methods consistent with certain disclosed embodiments. It is contemplated that one or more of the hardware components listed above may be implemented using software. For example, storage 530 may include a software partition associated with one or more other hardware components of system 500. System 500 may include additional, fewer, and/or different components than those listed above. It is understood that the components listed above are illustrative only and not intended to be limiting.

Processor 505 may include one or more processors, each configured to execute instructions and process data to perform one or more functions associated with system 500. As illustrated in FIG. 5, processor 505 may be communicatively coupled to RAM 510, ROM 520, storage 530, database 540, I/O module 550, and interface module 560. Processor 505 may be configured to execute sequences of computer program instructions to perform various processes, which will be described in detail below. The computer program instructions may be loaded into RAM for execution by processor 505.

RAM 510 and ROM 520 may each include one or more devices for storing information associated with an operation of system 500 and/or processor 505. For example, ROM 520 may include a memory device configured to access and store information associated with system 500, including information for identifying, initializing, and monitoring the operation of one or more components and subsystems of system 500. RAM 510 may include a memory device for storing data associated with one or more operations of processor 505. For example, ROM 520 may load instructions into RAM 510 for execution by processor 505.

Storage 530 may include any type of storage device configured to store information that processor 505 may need to perform processes consistent with the disclosed embodiments.

Database 540 may include one or more software and/or hardware components that cooperate to store, organize, sort, filter, and/or arrange data used by system 500 and/or processor 505. For example, database 540 may include user-specific account information, predetermined menu/display options, and other user preferences. Alternatively, database 540 may store additional and/or different information.

I/O module 550 may include one or more components configured to transmit information between the various components of communication system 400. For example, I/O module 550 may facilitate transmission of data between food preparation system 410, communication device 420, network 430, and/or database 440. I/O module 550 may further allow a user to input parameters associated with communication system 400 or any one or more of its components via a touchpad, keypad, touchscreen, or another input component of one or more of food preparation system 410 and communication device 420. I/O module 550 may also facilitate transmission of visual indicators (e.g., LED indicators) or display data including a graphical user interface (GUI) for outputting information onto a viewing surface or graphical display. I/O module 550 may also include peripheral devices such as, for example, ports to allow a user to input data stored on a portable media device, a microphone, or any other suitable type of interface device. I/O module 550 may also include ports to allow a user to output data stored within any component of communication system 400 to, for example, an external component.

Interface 560 may include one or more components configured to transmit and receive data via a communication network, such as the Internet, a local area network, a workstation peer-to-peer network, a direct link network, a wireless network, or any other suitable communication platform. For example, interface 560 may include one or more modulators, demodulators, multiplexers, demultiplexers, network communication devices, wireless devices, antennas, modems, and any other type of device configured to enable data communication via a communication network.

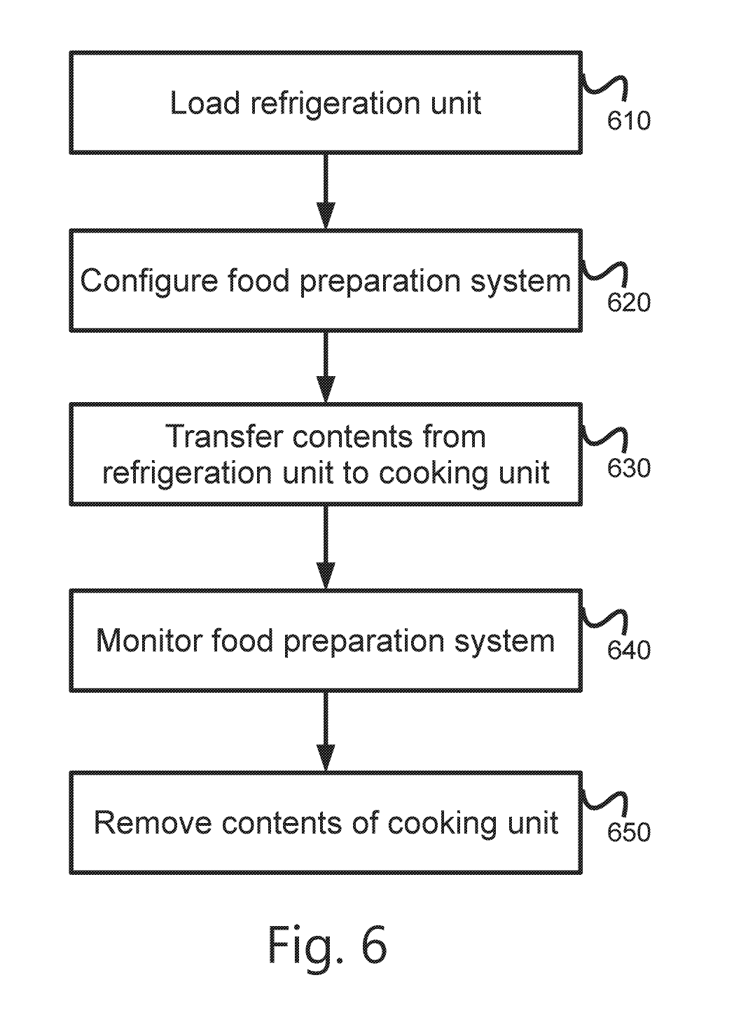

FIG. 6 depicts a method for configuring food preparation system. In one aspect, at step 610, a user can load ingredients and/or food items into refrigeration unit 140. Alternatively or additionally, the user may also load liquid ingredients into one or more reservoirs of support plate or container 158 of transportation unit 150.

The user may then configure aspects of food preparation system 100 at step 620. For example, the user may activate refrigeration unit 140, schedule a time for activation of refrigeration unit 140, set a temperature for refrigeration unit 140, schedule a temperature profile (i.e., configure temperature variations) for refrigeration unit 140, schedule the movement of items within refrigeration unit 140 to cooking unit 120, deactivate (i.e., turn off) refrigeration unit 140, schedule a time for deactivating refrigeration unit 140, schedule the activation of cooking unit 120, schedule a time for activation of cooking unit 120, set a temperature for cooking unit 120, schedule a temperature profile for cooking unit 120, deactivate (i.e., turn off) cooking unit 120, and/or schedule a time for deactivating cooking unit 120. Of course, these are only examples of aspects of food preparation system 100 that a user may configure. Other possibilities exist and the user may configure any suitable aspect of food preparation system 100.

At step 630, in response to an input of the user and/or in accordance with a schedule set by the user, the contents of refrigeration unit 140 may be transported to cooking unit 120. The contents of cooking unit 120 may then be heated and/or cooked in response to an input of the user or in accordance with a schedule set by the user.

At step 640, the user may monitor the state of food preparation system 100 either directly or remotely. In one embodiment, the user may receive information via network regarding one or more aspects of food preparation system 100, including but not limited to, the current state (i.e., on/off) of refrigeration unit 140, transportation unit 150, and/or cooking unit 120, the current temperature or temperature rate of change associated with refrigeration unit 140 and/or cooking unit 120, the location of any food items (i.e., whether food is still located in refrigeration unit 140 or whether food has been transported to cooking unit 120), and/or a time elapsed or remaining for any one or more aspects of a refrigeration/cooking schedule. Of course, these are only examples of aspects of food preparation system 100 that a user may monitor. Other possibilities exist and the user may monitor any suitable aspect of food preparation system 100. For example, food preparation system 100 may further comprise a camera for monitoring the appearance of system 100 in real-time or on a recorded basis.

At step 650, the cooking unit 120 may complete cooking or heating the contents delivered from refrigeration unit 140. In one embodiment, upon completion of a cooking schedule, cooking unit 120 may deactivate (i.e., turn off). In other embodiments, upon completion of a cooking schedule, cooking unit may maintain an internal temperature suitable for keeping any contents warm until a user removes them.

Additional features may also be incorporated into the described systems and methods to improve their functionality. For example, systems may include an alert system to notify a user when one or more aspects of food preparation system 100 fall outside predetermined thresholds and/or one or more components of system 100 are behaving unexpectedly. Database 440 may further comprise food preparation preferences or suggestions by other users, such that food preparation information is “crowd-sourced” and/or shared among members of a social network.

Other embodiments of the aforementioned systems and concepts will be apparent to those skilled in the art from consideration of the specification and practice of this disclosure. It is intended that the specification and examples be considered as illustrative only, with the true scope and spirit of the disclosure being indicated by the following claims.

What is claimed is:

1. A system for preparing food, the system comprising:
a refrigeration unit comprising a first aperture, an inner liner defining a refrigeration cavity, and a plurality of dynamic struts configured to support a food container;
a cooking unit comprising an interior cavity and a second aperture configured to receive the food item; and
a transportation unit comprising a cover and a support plate,
wherein the support plate of the transportation unit is configured to:
enter the refrigeration cavity through the first aperture;
strike at least one of the plurality of dynamic struts;
receive the food item;
exit the refrigeration cavity through the first aperture; and
enter the cooking unit through the second aperture such that the food item is positioned within the interior cavity of the cooking unit and the cover is positioned adjacent the second aperture.

2. The system of claim 1, wherein the cooking unit is positioned above the refrigeration unit.

3. The system of claim 2, wherein the first aperture of the refrigeration unit and the second aperture of the cooking unit reside in a first plane and a portion of the transportation unit is configured to move in a direction substantially parallel to the first plane.

4. The system of claim 3, wherein the portion of the transportation unit is further configured to move in a direction substantially perpendicular to the first plane.

5. The system of claim 4, wherein the transportation unit comprises a base portion configured to move in a direction substantially perpendicular to the first plane.

6. The system of claim 4, wherein the support plate of the transportation unit is positioned in a plane substantially perpendicular to the first plane.

7. The system of claim 4, wherein the cover of the transportation unit is positioned in a plane substantially parallel to the first plane.

8. The system of claim 1 wherein at least a portion of each of the plurality of dynamic struts extends above a lower surface of the inner liner of the refrigeration unit.

9. The system of claim 8, wherein the plurality of dynamic struts are configured to rotate about a point below the lower surface of the inner liner of the refrigeration unit upon contact with the support plate of the transportation unit.

10. The system of claim 8, wherein each of the plurality of dynamic struts are positioned within a respective opening in the lower surface of the inner liner of the refrigeration unit and are spring-urged away from the lower surface of the inner liner, such that upon contact with the support plate of the transportation unit, each of the plurality of dynamic struts in contact with the support plate is depressed toward the lower surface of the inner liner.

11. An apparatus for food preparation, the apparatus comprising:
a refrigeration unit comprising a first aperture, an inner liner defining a refrigeration cavity, and a plurality of dynamic struts configured to support a food item placed within the refrigeration cavity;
a cooking unit comprising a second aperture and an interior cavity configured to receive the food item; and
a transportation unit comprising a support plate and a cover, the support plate configured to enter the refrigeration unit through the first aperture, receive the food item, exit the refrigeration unit through the first aperture, and enter the cooking unit through the second aperture.

12. The apparatus of claim 11, wherein the transportation unit further comprises a base portion configured to slide in a plane substantially perpendicular to a first plane comprising the first and second aperture.

13. The apparatus of claim 12, wherein the transportation unit further comprises one or more vertical supports coupled to the base portion and configured to extend in a direction substantially parallel to the first plane.

14. The apparatus of claim 13, wherein at least one of the cover and support plate of the transportation unit is coupled to the one or more vertical supports such that both the cover and the support plate move in a direction substantially parallel to the first plane when the one or more vertical supports extends in a direction substantially parallel to the first plane.

15. The apparatus of claim 14, wherein both the cover and the support plate move in a direction substantially perpendicular to the first plane when the base portion slides in a plane substantially perpendicular to the first plane.

16. A device for food preparation, the device comprising:
a refrigeration unit comprising a first aperture and a first liner defining a refrigeration cavity;
a cooking unit comprising a second aperture and a second liner defining a cooking cavity; and
a transportation unit comprising a cover and a support plate, the support plate configured to move into and out of the first and second apertures,
wherein the refrigeration unit further comprises a platform located adjacent a lower surface of the refrigeration cavity and a plurality of dynamic support members configured to support a food item.

17. The device of claim 16, wherein each of the plurality of dynamic support members is positioned on an upper surface of the platform and one or more of the plurality of dynamic support members is configured to move with respect to the upper surface of the platform upon contact with the support plate of the transportation unit.

18. The device of claim 17, wherein one or more of the support members can slide along the upper surface of the platform upon contact with the support plate of the transportation unit.

19. The device of claim 17, wherein one or more of the support members rotates about a point located below the upper surface of the platform upon contact between the one or more support members and the support plate of the transportation unit.

20. The device of claim 17, wherein one or more of the support members is positioned in a respective opening in the upper surface of the platform and spring urged away from the upper surface such that, upon contact with the support plate of the transportation unit, each contacted support member is depressed into its respective opening in the platform.
